(19) United States
(12) Patent Application Publication
(10) Pub. No.: US 2020/0003943 A1
(43) Pub. Date: Jan. 2, 2020

(54) LIGHT EMITTING DEVICE AND DISPLAY DEVICE

(71) Applicant: SHARP KABUSHIKI KAISHA, Osaka (JP)

(72) Inventors: HIROSHI KITAMURA, Osaka (JP); MAKOTO AGATANI, Osaka (JP); HIDEKAZU FUJII, Osaka (JP)

(21) Appl. No.: 16/444,375

(22) Filed: Jun. 18, 2019

Related U.S. Application Data
(60) Provisional application No. 62/690,711, filed on Jun. 27, 2018.

(51) Int. Cl. F21V 8/00

(52) U.S. Cl. CPC G02B 6/0006; G02B 6/001

(57) ABSTRACT

[Object] To provide a light emitting device including individually controllable light source units, and a display device including the light emitting device.

[Solution] A light emitting device (15) is a light emitting device used in a display device including a display area, and includes a plurality of light source units (40) each including a light source portion (20) including laser diodes that emit three or more types of laser beams having wavelengths different from each other, and a light guide portion (30) that guides the laser beams. The plurality of light source units (40) are two-dimensionally arranged in the display area.

### TECHNICAL FIELD

The present invention relates to a light emitting device, and a display device including the light emitting device.

### BACKGROUND ART

A variety of types of liquid crystal display device Including a liquid crystal television set have been developed thus far. For example, NPL 1 discloses a liquid crystal display device including a surface light source including a laser diode emitting red (R) light, a laser diode emitting green (G) light, and a laser diode emitting blue (B) light alternately disposed on the left and right sides of the liquid crystal display device in the longitudinal direction, and a light guide rod corresponding to each laser diode.

PTL 1 discloses a surface light emitting device that includes a laser element, a linear light guide rod for guiding laser beams, and a light guide plate that converts the light into surface emitting light and outputs the light.

### CITATION LIST

### Patent Literature

[PTL 1] Japanese Unexamined Patent Application Publication No. 2017-091984

### Non Patent Literature

[NPL 1] “RGB Laser-Backlight Liquid Crystal Display”, by Eiji NIIKURA, ITU Journal Vol. 46, No. 2 (2016, 2), pp. 32 to 35

### SUMMARY OF INVENTION

### Technical Problem

The liquid crystal display device according to NPL 1 guides laser beams that emit monochromatic light of any of red, green, and blue to each light guide rod, and thus has a problem of a low color mixture characteristics of laser beams. In order for the liquid crystal display device according to NPL 1 to produce uniform surface emitting light, the light guide rod and a display panel need to be spaced a certain distance apart from each other, so that the liquid crystal display device has a problem of an increase of the thickness. The liquid crystal display device according to NPL 1 also needs an auxiliary member (such as a flutter structure) to enhance the color mixture characteristics, which causes a problem of a cost increase.

The surface light source device according to PTL 1 has problems of increases of thickness, weight, and costs of the surface light source device and poor marketability.

To be included in display devices, light source devices preferably include an individually controllable light source per area unit.

An aspect of the present invention is provided to solve the above existing problems, and aims to provide a light emitting device including individually controllable light source units, and a display device including such a light emitting device.

### Solution to Problem

(1) To solve the above-described problems, a light emitting device according to an aspect of the present invention is a light emitting device used in a display device including a display area. The light emitting device includes a plurality of light source units each including a light source portion including laser diodes that emit three or more types of laser beams having wavelengths different from each other, and a light guide portion that guides the laser beams, wherein the plurality of light source units are two-dimensionally arranged in the display area.

(2) In a light emitting device according to an aspect of the present invention, in addition to the structure (1), all the laser diodes may have luminescence centers located on an inner area of an end surface of the light guide portion.

(3) in a light emitting device according to an aspect of the present invention, in addition to the structure (1) or (2), the light source portion may be disposed on each of two ends of the light guide portion.

(4) In a light emitting device according to an aspect of the present invention, in addition to the structure (3), each of the light source portions disposed on a first or second one of the two ends of the light guide portion may include a laser diode that emits laser beams having a wavelength different from a wavelength of laser beams emitted from a laser diode included in the light source portion disposed on the other one of the two ends.

(5) In a light emitting device according to an aspect of the present invention, in addition to the structure (1) or (2), the light source portion may be disposed on a first end of the light guide portion, and a reflection sheet that reflects light from the light guide portion or an end surface of the light guide portion subjected to reflection processing may be disposed on a second end of the light guide portion.

(6) in a light emitting device according to as aspect of the present invention, in addition to any one of the structures (1) to (5), the light source portion may include two or more of the laser diodes that emit laser beams of the same wavelength range for each light guide portion.

(7) In a light emitting device according to an aspect of the present invention, in addition to any one of the structures (1) to (6), in the plurality of light source units, outputs emitted from the laser diodes may be controllable independently of each other.

(8) A light emitting device according to an aspect of the present invention, in addition to any one of the structures (1) to (7), may further include a light receiving element and a controller. The controller may control laser light outputs of at least one of the plurality of light source units based on detection results from the light receiving element.

(9) A light emitting device according to an aspect of the present invention, in addition to any one of the structures (1) to (8), a reflector or a light guide member subjected to reflection processing may be disposed on a side of each light source unit opposite to an irradiation side.

(10) A light emitting device according to an aspect of the present invention, in addition to any one of the structures (1) to (9), the light guide portion may have a rod shape or a semicircular shape in a side view, and a plurality of rows each including the plurality of light source units may be arranged in the display area in a plan view.

(11) A light emitting device according to an aspect of the present invention, in addition to any one of the structures (1) to (10), each light guide portion may have a first end and a second end disposed on the light source portion to allow the light source unit to form a circular shape or an elliptic shape.

(12) A light emitting device according to an aspect of the present invention, in addition to any one of the structures (1) to (11), each light guide portion may have a coil shape in a plan view.

(13) A light emitting device according to an aspect of the present invention, in addition to any one of the structures (1) to (12), the light guide portion may have a letter U shape in a plan view, and the plurality of light source units may be arranged in the display area in a plan view so that the letter U shapes of the light guide portions alternate each other.

(14) To solve the above problems, a display device according to an aspect of the present invention includes the light emitting device according to any one of the structures (1) to (13) as a backlight.

### Advantageous Effects of Invention

An aspect of the present invention can provide a light emitting device including individually controllable light source units, and a display device including such a light emitting device.

### BRIEF DESCRIPTION OF DRAWINGS

Part (a) of FIG. 1 is an exploded perspective view schematically illustrating a display device including a light emitting device according to a first embodiment of the present invention, and part (b) of FIG. 1 is a perspective view of another arrangement example of light source units in the light emitting device.

FIG. 2 is a schematic diagram of a structure including light source units incorporated in the light emitting device of FIG. 1, where part (a) of FIG. 2 illustrates one of the light source units, and part (b) of FIG. 2 illustrates a light emitting device including multiple light source units.

Part (a) of FIG. 3 illustrates the light source unit illustrated in FIG. 2, and part (b) of FIG. 3 is an exploded perspective view schematically illustrating part of the light emitting device viewed from the light guide portion.

FIG. 4 is a graph showing an example of the relationship between the wavelength and the radiant intensity peak of laser beams emitted from the light source portion.

FIG. 5 is arrangement examples of light source units of the light emitting device according to the first embodiment of the present invention.

FIG. 6 is other arrangement examples of light source units of the light emitting device according to the first embodiment of the present invention.

FIG. 7 illustrates a light source unit of a light emitting device according to a second embodiment of the present invention.

FIG. 8 illustrates a light source unit of a light emitting device according to a third embodiment of the present invention.

FIG. 9 illustrates a light source unit of a light emitting device according to a fourth embodiment of the present invention.

FIG. 10 illustrates first arrangement examples of light source units of light emitting devices according to embodiments of the present invention.

FIG. 11 illustrates second arrangement examples of light source units of light emitting devices according to embodiments of the present invention.

FIG. 12 illustrates third and fourth arrangement examples of light source units of light emitting devices according to embodiments of the present invention.

### DESCRIPTION OF EMBODIMENTS

### First Embodiment

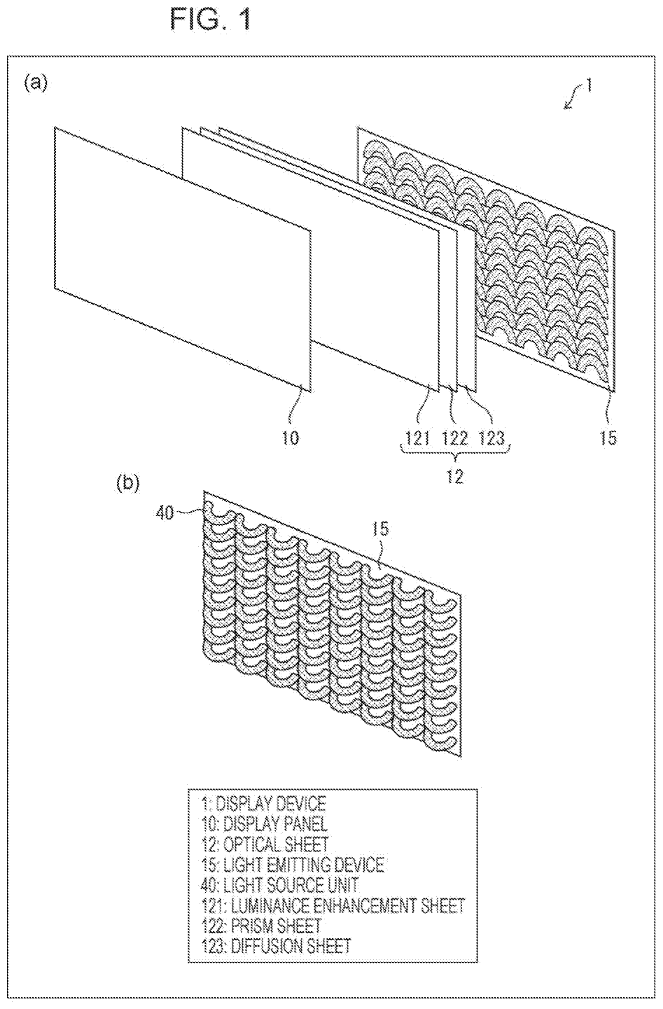

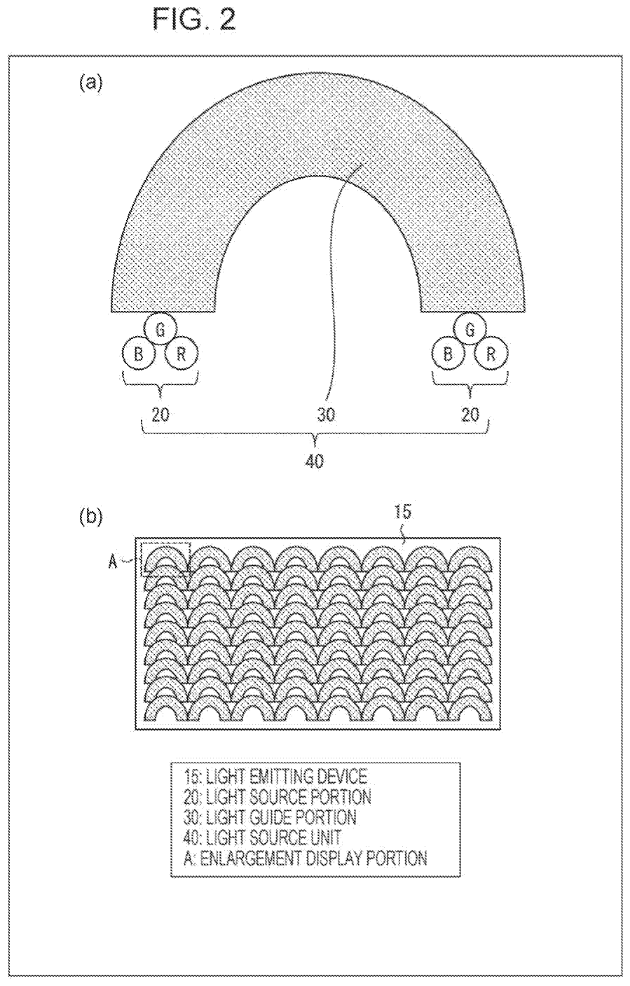

A display device including a emitting device according to the present embodiment will now be described with reference to FIG. 1 and FIG. 2. A light emitting device according to the present invention is preferably usable as, for example, a backlight of a display device.

### Structure of Display Device

Part (a) of FIG. 1 is an exploded perspective view schematically illustrating a display device 1 including a light emitting device 15 according to the present embodiment, and part (b) of FIG. 1 is a perspective view illustrating another arrangement example of light source units 40 in the light emitting device 15. FIG. 2 is a schematic diagram of a structure in which light source units are incorporated n the light emitting device of FIG. 1, where part (a) of FIG. 2 illustrates one of the light source units 40, and part (b) of FIG. 2 illustrates a light emitting device 15 including multiple light source units 40.

As illustrated in FIG. 1 and FIG. 2, the display device 1 according to the present embodiment includes a display panel 10 including a display area, an optical sheet 12, and the light emitting device 15 serving as a backlight.

The display panel 10 displays images based on input electric signals. The optical sheet 12 condenses or diffuses light emitted from the light emitting device 15, and efficiently emits light to the display panel 10. In the present embodiment, the optical sheet 12 includes a luminance enhancement sheet 121, a prism sheet 122, and a diffusion sheet 123, but the structure of the optical sheet 12 is not limited to this.

Although described later in detail, as illustrated in FIG. 1 and FIG. 2, multiple light source units 40 are disposed in the display area, and each light source unit 40 includes light source portions 20 and a light guide portion. 30. In the example illustrated in part (a) of FIG. 1, multiple light source units 40 are arranged in the lateral direction and the vertical direction of the light emitting device 15 so that the height direction of the arch of the light guide portion 30 is aligned with the surface direction of the light emitting device 15. In the example illustrated in part (b) of FIG. 1, the multiple light source units 40 are arranged in the lateral direction and the vertical direction of the light emitting device 15 so that the height direction of the arch of the light guide portion 30 is aligned with the direction normal to the light emitting device 15. In the example illustrated in part (b) of FIG. 2, 72 light source units 40 in 9 rows×8 columns are disposed in the display area. However, the number of light source units 40 is not limited to this. One of the light source units 40 illustrated in part (b) of FIG. 2 is illustrated in an enlarged form in part (a) of FIG. 2.

### Structure of Light Emitting Device

A light emitting device 15 according to the present embodiment will now be described in detail with reference to FIG. 3 to FIG. 6.

Part (a) of FIG. 3 illustrates the light source unit 40 illustrated in FIG. 2, and part (b) of FIG. 3 is an exploded perspective view schematically illustrating part of the light emitting device viewed from the light guide portion 30. As described above, each light source unit 40 includes the light source portions 20 and the right guide portion 30.

In the example illustrated in FIG. 3, each light source portion 20 includes three laser diodes 20b, 20g, and 20r. The laser diode 20b emits blue laser beams (“(B) right beams”, below). The laser diode 20g emits green laser beams (“(G) light beams”, below). The laser diode 20r emits red laser beams (“(R) light beams”, below). The light source portion 20 including three laser diodes has been described by way of example. However, the structure of the light source portion 20 is not limited to this.

The light guide portion 30 is disposed so as to oppose the light source portions 20 to guide laser beams emitted by the light source portions 20. Specifically, the light guide portion 30 according to the present embodiment has a semicircular shape in a side view, as illustrated in part (a) of FIG. 3, and has a first end surface 31a and a second end surface 31b on both ends. The two light source portions 20 face the first end surface 31a and the second end surface 31b of the light guide portion 30.

In the present embodiment, as illustrated in part (a) and part (b) of FIG. 3, with respect to the first end surface 31a and the second end surface 31b of the light guide portion 30, the luminescence centers of all the laser diodes are located on the inner areas of the first end surface 31a and the second end surface 31b of the light guide portion 30. In other words, the luminescence centers of all the laser diodes are located on the inner side of the outer edges of the first end surface 31a and the second end surface 31b of the light guide portion 30.

According to the above structure, the light guide portion 30 can preferably guide light.

The light guide portion 30 may be formed from any material that can guide laser beams emitted from the laser diodes of the light source portion 20. Examples of a base material (core material) for the light guide portion 30 include an acrylic resin and polyurethane. The index of refraction of the material of the light guide portion 30 is not limited to a particular one and may be, for example, 1.44 to 1.55. The light guide portion 30 may be coated with a covering material (cladding material) formed of, for example, transparent Teflon (registered trademark), as appropriate. Here, the index of refraction of the covering material is not limited to a particular one, and may be, for example, 1.33 to 1.44. The light guide portion 30 may also include a diffuser (not illustrated) for uniformly emitting laser beams.

Here, a side view refers to a view in a direction perpendicular to the direction normal to the display area. A plan view in the following description refers to a view in the direction normal to the display area.

As illustrated in part (b) of FIG. 3, the light guide portion 30 is removably attached to a heat sink (heat-dissipating member) 21. The heat sink 21 is formed from a highly thermally conductive metal member made of, for example, a metal such as aluminum or an alloy.

As described above, in the present embodiment, the light emitting device 15 is a light emitting device used in the display device 1 including the display area, and Includes the multiple light source units 40. Each light source unit 40 includes the light source portions 20, each of which includes the laser diodes 20r, 20b, and 20g that emit three or more types of laser beams having wavelengths different from each other, and the light guide portion 30 that guides the laser beams. The multiple light source units 40 are two-dimensionally arranged in the display area.

With the above structure, the present embodiment can provide a light emitting device including the individually controllable light source units 40.

### Details of Light Source Portion

Subsequently, laser beams emitted from the laser diodes 20b, 20g, and 20r constituting one light source portion 20 will now be described in detail.

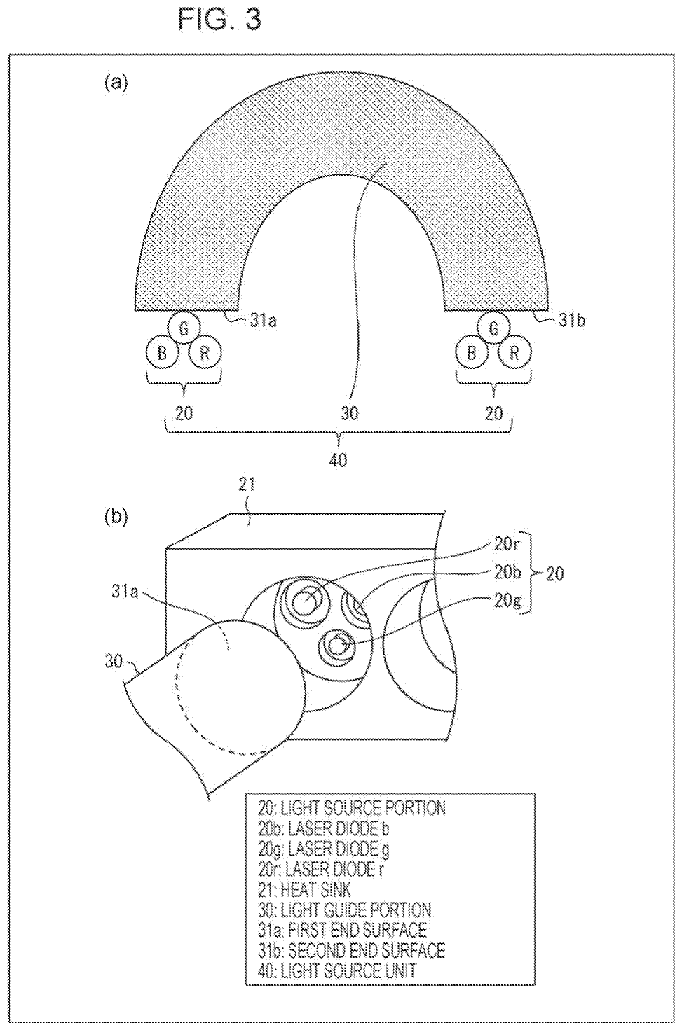

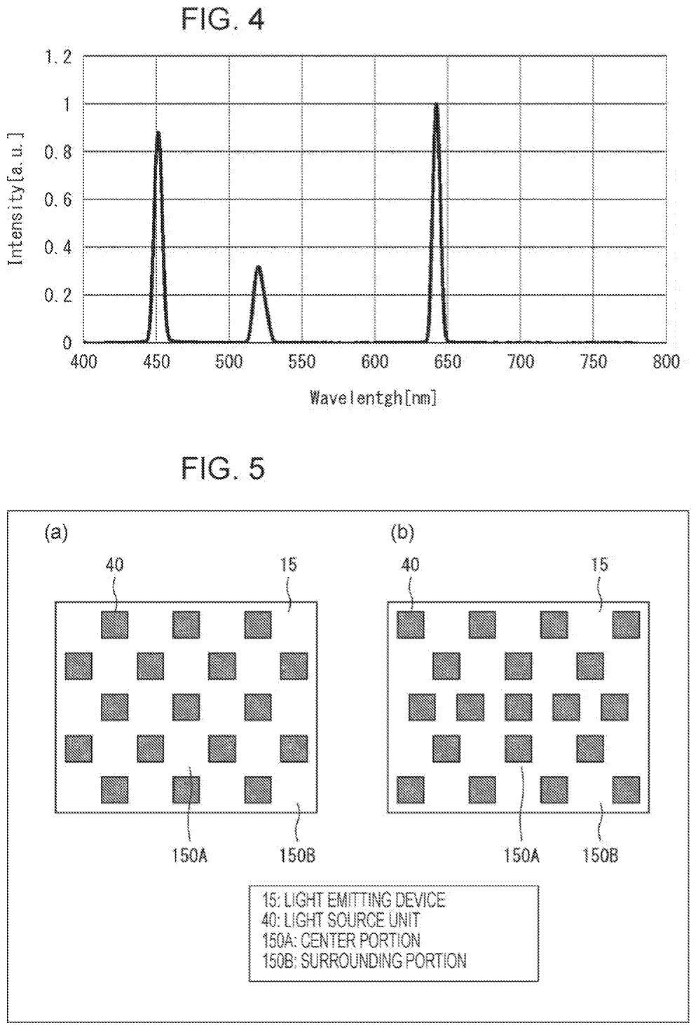

FIG. 4 is a graph showing an example of the relationship between the wavelength and the intensity of laser beams emitted from the light source portions 20.

With reference to FIG. 4, the laser diode 20b emits laser beams having a first intensity peak within the range of 440 to 477 nm. The laser diode 20g emits laser beams having a second intensity peak within the range of 505 to 542 nm. The laser diode 20r emits laser beams having a third intensity peak within 620 to 660 nm. As examples of a preferable wavelength of laser beams emitted from the laser diodes 20b, 20g, and 20r, the laser diode 20b emits laser beams having a first intensity peak of around 467 nm, the laser diode 20g emits laser beams having a second peak of around 532 nm, and the laser diode 20r emits laser beams having a third intensity peak of around 630 nm.

### First Arrangement Examples of Light source Units

First arrangement examples of light Source units according to the present embodiment will now be described in detail with reference to FIG. 5. As illustrated in FIG. 5, compared to a surrounding portion 150B of the display area, more light source units 40 are disposed in a center portion 150A of the display area. To more brightly display the center portion 150A of the display area, more light source units 40 may be disposed in the center portion 150A of the display area than in the surrounding portion 150B.

The above structure can preferably more brightly display the center portion 150A of the display area in the present embodiment.

### Second Arrangement Examples of Light source Units

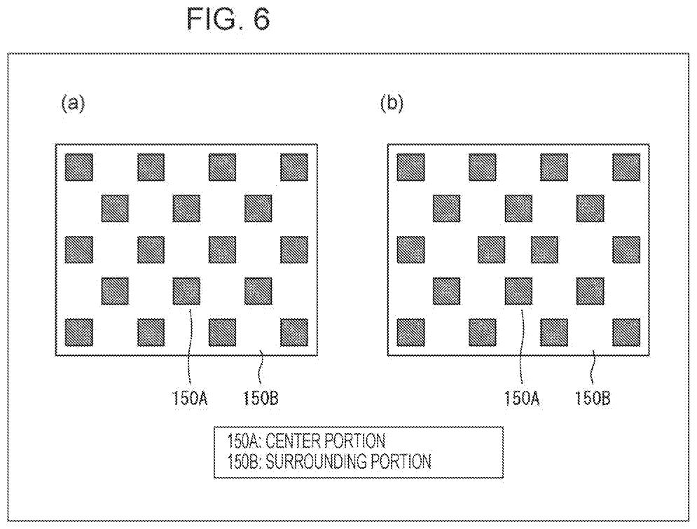

The arrangement of the light source units 40 may be changed to the ones illustrated in FIG. 6. When the arrangement of the light source units 40 is intentionally changed to the ones in FIG. 5 or FIG. 6, the uniformity (luminance unevenness at four corners) in the display area can be improved or the center luminance can be enhanced.

### Operations and Effects of Present Embodiment

Subsequently, the operations and effects of the display device 1 and the light emitting device 15 will be described again with reference to FIG. 1 to FIG. 6.

In the light emitting device 15, when the laser diodes 20b, 20g, and 20r of the two light, source portions 20 at both ends of the light guide portion 30 emit (B), (G), and (R) light beams, these laser beams are incident on the first end surface 31a and the second end surface 31b of the light guide portion 30, and guided to the center portion of the light guide portion 30. The (G), (B), and (R) light beams are then mixed in the light guide portion 30, and the mixed light beams are emitted from the light emitting device 15.

According to the light emitting device 15, three types of laser beams having wavelengths different from each other are mixed in one light guide portion 30, thereby improving the color mixture characteristics. The heat sink 21 holds the light guide portion 30 in a predetermined position. The laser beams emitted from the light source portions 20 are thus efficiently incident on the end surfaces of the light guide portion 30. The present embodiment can thus provide a light emitting device including individually controllable light source units. Thus, the light emitting device 15 used as a backlight can achieve a display device such as a next-generation flat-screen television fully satisfying the color gamut standards (BT2020) required for broadcasting in 4K or 8K.

### Second Embodiment

A light emitting device according to a second embodiment of the present invention will now be described below. For convenience of illustration, components having the same functions as those described in the embodiment are denoted with the same reference signs and not described repeatedly.

The light source portion according to the present embodiment has a structure different from that of the first embodiment. The different points are mainly described below.

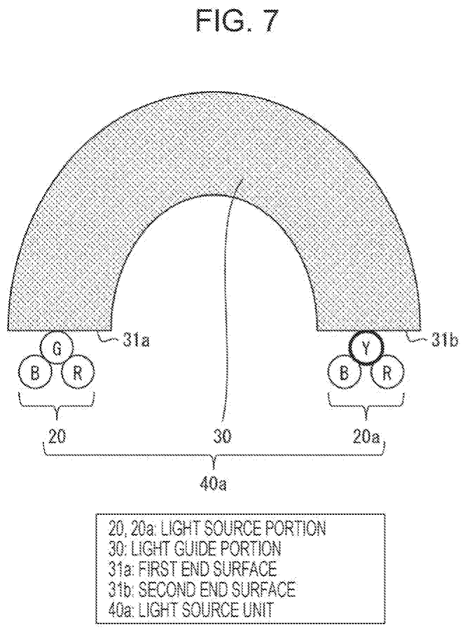

A display device including a light emitting device according to the present embodiment will now be described with reference to FIG. 7. FIG. 7 illustrates a light source unit 40a of a light emitting device according to the second embodiment. As illustrated in FIG. 7, the light source unit 40a includes light source portions 20 and 20a and a light guide portion 30.

In the present embodiment, compared to the light source portion 20, the light source portion 20a includes a laser diode that emits yellow (Y) laser beams in place of the laser diode that emits green (G) laser beams. Thus, the light source portions 20 on both ends of the light guide portion 30 include the light source portion 20 that is disposed on a first one of the ends and that includes laser diodes that emit laser beams having a different wavelength from that of laser beams emitted from laser diodes of the light source portion 20 disposed a second one of the ends.

The above structure can improve the luminance of light emitted from the light emitting device and the color gamut or light that has passed through the display panel 10.

To enhance the above effect, preferably, the liquid crystal display device 1 includes a liquid crystal panel as a display panel, and has color filters for four colors (RGBY).

Another structure example may have a structure including laser diodes that emit, for example, cyan (C) laser beams, to allow laser beams of four colors of (B), (G), (R), and (C) to be incident on the end surfaces of the light guide portion 30. This structure can enhance the color gamut when light emitted from the light emitting device passes through the display panel 10.

To enhance the above effect, preferably, the liquid. crystal display device 1 includes a liquid crystal panel as a display panel, and color filters for four colors (RGBC).

Other examples of laser beam combinations according to other aspects include a combination of (B), (C), (Y), and (R) laser beams and a combination of (B), (C), (G), and (R) laser beams, or (B), (C), (G), (Y), and (R) laser beams.

### Third Embodiment

A light emitting device according to a third embodiment of the present invention will now be described, below. For convenience of illustration, components having the same functions as those described in the above embodiments are denoted with the same reference signs and not described repeatedly.

The light source portion according to the present embodiment has a structure different from those of the first and second embodiments. The different points are mainly described, below.

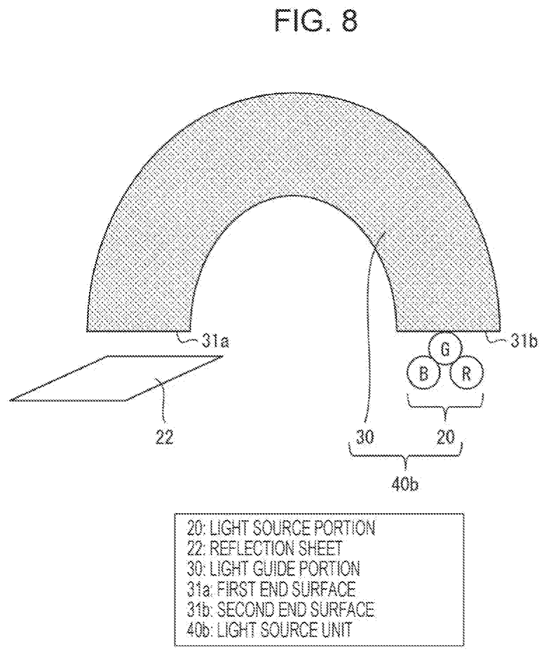

A display device including a emitting device according to the present embodiment will now be described with reference to FIG. 8, below. FIG. 8 illustrates a light source unit 40b of the light emitting device according to the third embodiment. As illustrated in FIG. 8, the light source unit 40b includes a light source portion 20, a reflection sheet 22, and a light guide portion 30.

In the present embodiment, the (B), (G) and (R) light beams are emitted from the laser diodes 20b, 20g, and 20r of the light source portion 20 disposed at one end of the light guide portion 30, and the light beams are then incident on, for example, the second end surface 31b of the light guide portion 30 and guided toward the center portion of the light guide portion 30. The laser beams emitted from the first end surface 31a of the light guide portion 30 are then reflected by the reflection sheet 22 into the light guide portion 30. The (G), (B) and (R) light beams are then mixed, and the mixed light beams are emitted from the light emitting device.

As described above, the light source portion 20 is disposed at one end of the light guide portion 30, and a reflection sheet 22, which reflects light beams from the light guide portion 30, is disposed at the other end of the light guide portion 30.

The above structure also has the similar effects to the first embodiment.

### Modification Example According to Third Embodiment

A modification example of the third embodiment will now be described, below. For convenience of illustration, components having the same functions as those described in the above embodiments are denoted with the same reference signs and not described repeatedly.

The structure of this modification example is different from that of third embodiment in that it does not include a reflection sheet. This different point is mainly described, below.

In this modification example, to reflect light from the light guide portion 30, the end surface 31a of the light guide portion 30 is coated or subjected to other processing with another method to enhance the reflectance of the end surface. This structure also has the similar effects to the third embodiment.

### Fourth Embodiment

A light emitting device according to a fourth embodiment of the present invention will now be described, below. For convenience of illustration, components having the same functions as those described in the above embodiments are denoted with the same reference signs and not described repeatedly.

The light source portion according to the present embodiment has a structure different from those of the first to third embodiments. The different points are mainly described, below.

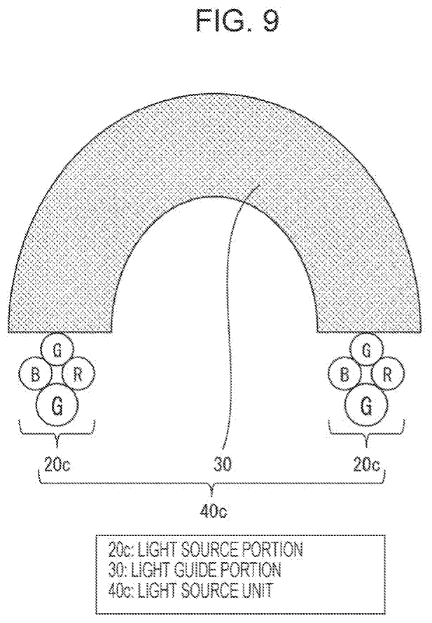

A display device including a emitting device according to the present embodiment will now be described below with reference to FIG. 9. FIG. 9 illustrates a light source unit 40c of a light emitting device according to a fourth embodiment. As illustrated in FIG. 9, the light source unit 40c includes light source portions 20c and a light guide portion 30.

The light source portions 20c according to the present embodiment are different from the light source portions 20 in that each light source portion 20c includes two laser diodes 20g that emit green (G) laser beams. Thus, each light source portion 20 includes two or more laser diodes that emit laser beams in the same wavelength range for the corresponding light guide portion 30. This structure can compensate for the shortage of the amount of laser beams of the entire light emitting device.

In the present embodiment, in the multiple light source units 40c, outputs emitted from the laser diodes may be controllable independently of each other. The structure having the independently controllable outputs is preferably applicable to the first to third embodiments. This structure enables individual light emission control in a small display area, that is, local dimming.

The present embodiment may also include a light receiving element and a controller, not illustrated, and the controller may control the laser fight outputs from at least one of the multiple laser diodes (in other words, at least one of the multiple light source units 40) based on the detection results from the light receiving element. This structure is preferably applicable to the first to third embodiments. The light receiving element is preferably a color sensor. This structure enables control of the luminance and chromaticity of the light emitting device.

The present embodiment may also include a reflector or a light guide member subjected to reflection processing, not illustrated, disposed on the surface of each light source unit 40c opposite to the irradiation side (facing the display panel 10). This structure is preferably applicable to the first to third embodiments. This structure can more effectively provide light emitted from the fight emitting device to the display panel 10.

Thus far, the structures of the Light source units according to the first to fourth embodiments have been described. Hereinbelow, arrangement examples preferably applicable to the first to fourth embodiments are specifically described in detail by way of example.

### Light Source Units of First Arrangement Examples

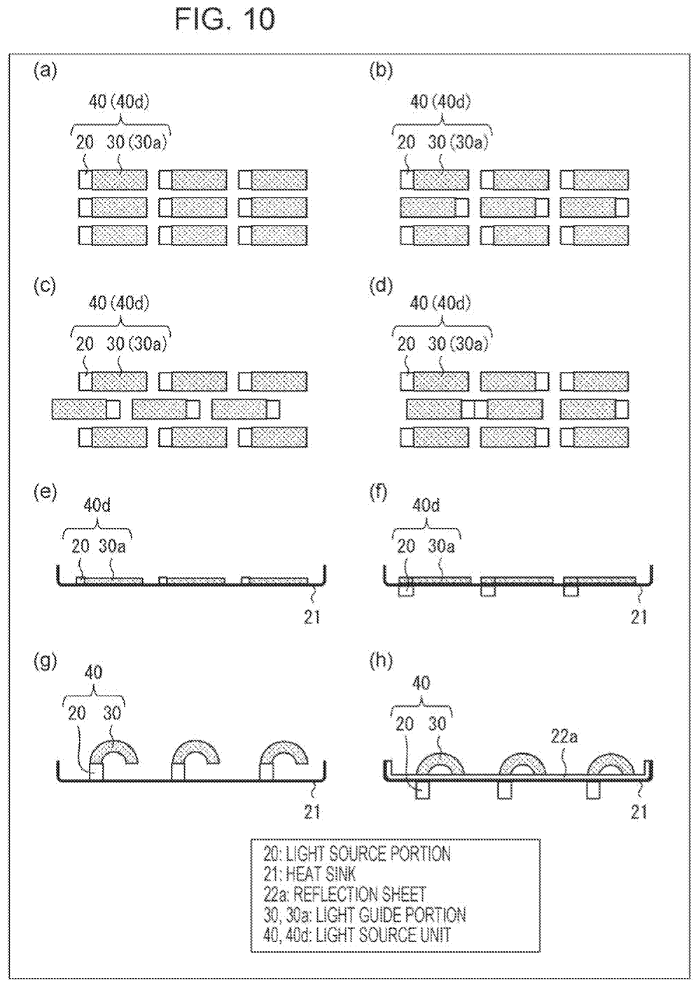

FIG. 10 is first arrangement examples of the light source units of the light emitting devices according to the above embodiments. As illustrated in part (a) of FIG. 10, each of light source units 40d (40) includes a light source portion 20 and a light guide portion 30a (30). In the example illustrated in part (a) of FIG. 10, the light source units 40d are arranged so that the light source portions 20 in each row are oriented in the same direction. In the example illustrated in part (b) of FIG. 10, the light source portions 20 in different rows are respectively disposed on different sides. In the example illustrated in part (c) of FIG. 10, a first row and a second row adjacent to the first row are arranged with offset (misalignment) between each other. In the example illustrated in part (d) of FIG. 10, the light source portions of two light source units in a row face each other. Part (a) to part (d) in FIG. 10 are plan views of the light source units 40d (40).

Part (e) to part (f) in FIG. 10 are side views of the light source units 40d (40). As illustrated in part (e) to part (f) in FIG. 10, each light source unit 40d includes a rod-shaped light guide portion 30a and a light source portion 20. The light guide portions illustrated in part (g) to part (h) in FIG. 10 have a semicircular shape in a side view, unlike the light guide portions illustrated in part (e) to part (f) in FIG. 10. In part (e) to part (h) in FIG. 10, the reference sign 21 denotes a heat sink, and the reference sign 22a denotes a reflection sheet.

As described above, the light guide portions 30 each have a rod shape or semicircular shape in a side view, and multiple rows each including multiple light source units 40 are arranged in the display area in a plan view. In this structure, an increase of the number of light source units enables an increase of the number of sections for local dimming.

### Second Arrangement Examples of Light Source Units

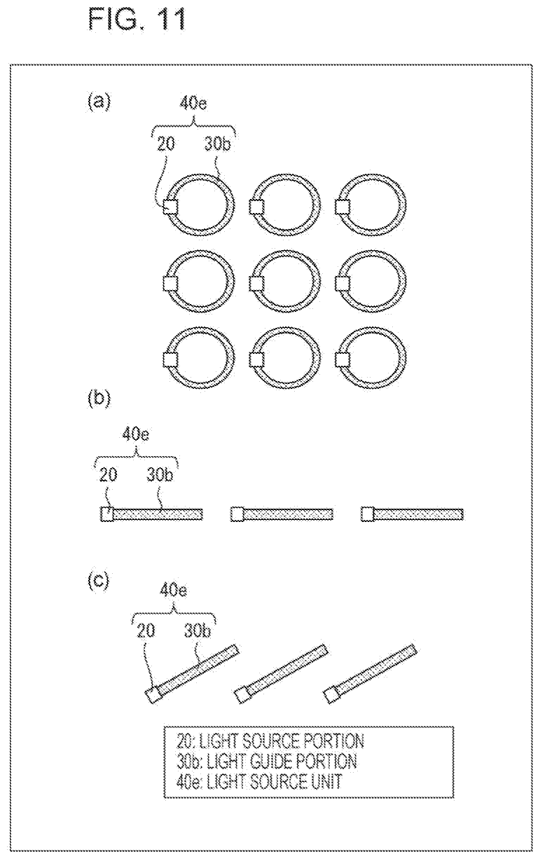

FIG. 11 illustrates second arrangement examples of the light source units of the light emitting devices of the above embodiments. As illustrated in part (a) of FIG. 11, in a plan view, light source units 40e each include a circular or elliptical light guide portion 30b and a light source portion 20. Thus, each light guide portion 30b has a first end and a second end disposed on the light source portion 20 to form the light source units 40e into a circular or elliptical shape. Also in this structure, an increase of the number of light source units enables an increase of the number of sections for local dimming.

Part (b) to part (c) in FIG. 11 illustrate the light source units 40e in a side view. In the example illustrated in part (b) of FIG. 11, in a side view, the light source units 40e are linearly arranged. On the other hand, in the example illustrated in part (c) of FIG. 11 in a plan view (in other words, when viewed from the top of FIG. 11), the light source portion of a certain light source unit is disposed to be covered with the light guide portion of another light source unit adjacent to the certain light source unit.

### Third and Fourth Arrangement Examples of Light Source Units

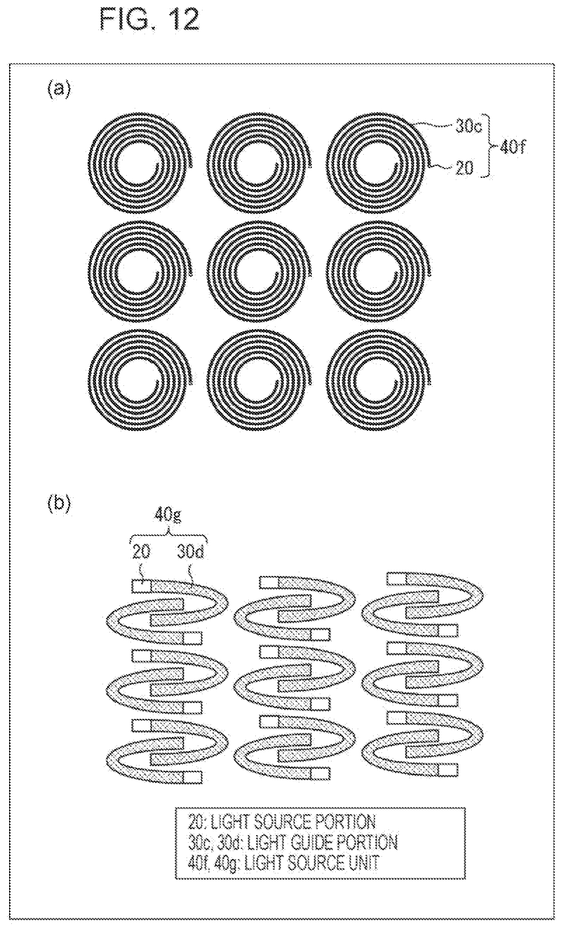

FIG. 12 illustrates third and fourth arrangement examples of the light source units of the light emitting devices according to the above embodiments.

As illustrated in part (a) of FIG. 12, in a plan view, multiple fight source units 40f are arranged in the display area. More specifically, in a plan view, a light guide portion 30C of each light source unit 40f has a coil shape. This structure with a coil shape has the same effects as the first and second arrangement examples, and enhances the color mixture characteristics further than the structure having, for example a circular shape.

As illustrated in part (b) of FIG. 12, in a plan view, multiple light source units 40g are arranged in the display area. More specifically, in a plan view, a light guide portion 30d of each light source unit 40g has a letter U shape. In a plan view, multiple light source units 40g are arranged in the display area so that the letter U shapes of the light guide portions 30d alternate each other. This structure also has the same effects as the first to third arrangement examples, and enhances the color mixture characteristics further than the structure having, for example, a circular shape.

Thus far, the first to fourth arrangement examples of the light source units are described separately. However, a combination of these arrangement examples may be arranged in the display area.

The present invention is not limited to the above-described embodiments, and may be changed in various manners within the scope of claims. Embodiments obtained by combining technical means disclosed in different embodiments as appropriate are also included in the technical scope of the present invention. In addition, new technical features may be formed by combining technical means disclosed in different embodiments.

### REFERENCE SIGNS LIST

1 display device
10 display panel
12 optical sheet
15 light emitting device
20, 20a, 20b light source portion
21 heat sink
22, 22a reflection sheet
30, 30a to 30d light guide portion
31a first end surface 31b second end surface
40, 40a to 40g light source unit
150A center portion
150B surrounding portion

1. A light emitting device used in a display device including a display area, comprising:
a plurality of light source units each including
a light source portion including laser diodes that emit three or more types of laser beams having wavelengths different from each other, and
a light guide portion that guides the laser beams,
wherein the plurality of light source units are two-dimensionally arranged in the display area.

2. The light emitting device according to claim 1,
wherein all the laser diodes have luminescence centers located on an inner area of an end surface of the light guide portion, with respect to the end surface of the light guide portion.

3. The light emitting device according to claim 1,
wherein the light source portion is disposed on each of two ends of the light guide portion.

4. The light emitting device according to claim 3,
wherein, each of the light source portions disposed on a first or second one of the two ends of the light guide portion includes a laser diode that emits laser beams having a wavelength different from a wavelength of laser beams emitted from a laser diode included in the light source portion disposed on the other one of the two ends.

5. The light emitting device according to claim 1,
wherein the light source portion is disposed on a first end of the light guide portion, and a reflection sheet that reflects light from the light guide portion or an end surface of the light guide portion subjected to reflection processing is disposed on a second end of the light guide portion.

6. The light emitting device according to claim 1,
wherein the light source portion includes two or more of the laser diodes that emit laser beams in an identical wavelength range for each light guide portion.

7. The light emitting device according to claim 1,
wherein, in the plurality of light source units, outputs emitted from the laser diodes are controllable independently of each other.

8. The light emitting device according to claim 1, further comprising:
a light receiving element; and
a controller,
wherein the controller controls laser light outputs of at least one of the plurality of light source units based on detection results from the light receiving element.

9. The light emitting device according to claim 1,
wherein a reflector or a light guide member subjected to reflection processing is disposed on a side of each light source unit opposite to an irradiation side.

10. The light emitting device according to claim 1,
wherein the light guide portion has a rod shape or a semicircular shape in a side view, and
wherein a plurality of rows each including the plurality of light source units are arranged in the display area in a plan view.

11. The light emitting device according to claim 1,
wherein each light guide portion has a first end and a second end disposed on the light source portion to allow the light source unit to form a circular shape or an elliptic shape.

12. The light emitting device according to claim 1,
wherein each light guide portion has a coil shape in a plan view.

13. The light emitting device according to claim 1,
wherein the light guide portion has a letter U shape in a plan view, and
wherein the plurality of light source units are arranged in the display area in a plan view so that the letter U shapes of the light guide portions alternate each other.

14. A display device, comprising the light emitting device according to claim 1 as a backlight.
